(19) United States
(12) Patent Application Publication
(10) Pub. No.: US 2002/0121264 A1
(43) Pub. Date: Sep. 5, 2002

(54) Fuel injection mechanism for diesel engine

(76) Inventor: Buom-Sik Shin, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 09/953,333

(22) Filed: Sep. 14, 2001

(30) Foreign Application Priority Data
Sep. 14, 2000 (KR) 2000-53931

(51) Int. Cl. F02B 3/00; F02M 59/00

(52) U.S. Cl. 123/299; 239/533.2

(57) ABSTRACT

A fuel injection mechanism for a diesel engine includes a fuel injector, a driving part connected to the fuel injector for actuating the fuel injector, and a controller electrically connected to the driving part for controlling the driving part.

### BACKGROUND OF THE INVENTION

(a) Field of the Invention

The present invention relates to a fuel injection mechanism for a diesel engine, and in particular, to a fuel injection mechanism capable of improving engine performance and reducing emission gases while a vehicle is running at a low speed.

(b) Description of the Related Art

Since a diesel engine is more economical than a gasoline engine and has much more torque, it is adapted to heavy vehicles such as trucks and buses. Because such vehicles are generally driven a high number of kilometers each year, it is particularly advantageous to maximize their fuel economy and torque and to minimize their emissions.

FIG. 1 shows a behavior of a fuel mist sprayed into a combustion chamber 11 by a fuel injector 10 in a conventional diesel engine.

The fuel mist swirls in the combustion chamber 11 according to a contour of an upper surface of a piston and is mixed with air therein such that the mixture is burned at a power stroke of the engine.

In this case, engine performance is affected by the spray pattern of the fuel injector and where the fuel is sprayed. Normally, it is preferred that the spray position be deep at high speed and shallow at low speed.

FIG. 2 is a graph illustrating smoke exhausted when the injection position is changed.

As shown in FIG. 2, the injection position affects the amount of smoke exhausted per given air-fuel ratio, and the injection position can be adjusted by changing a thickness of an injector gasket.

FIG. 3 is a graph illustrating a variation of engine torque in accordance with engine rpm. The graph shows that the engine torque is enhanced when the injection position is deeply set, and this means emission gases can be reduced by more deeply setting the injection position at the same air/fuel ratio.

In this case, however, injection position adjustment is impossible after the engine is assembled.

FIG. 4 schematically shows a conventional fuel injector for a diesel engine.

The fuel injector includes a housing 21 having two fuel injection ports 22 and a stem 23 having two spray valves 24 formed correspondingly to the fuel injection ports 22 at an end portion of the stem 23.

However, since the fuel injection ports 22 are fixedly placed, it is impossible to adjust the injection position.

### SUMMARY OF THE INVENTION

The present invention has been made in an effort to solve the above problems of the prior art.

It is an object of the present invention to provide a fuel injector capable of adjusting spraying amount and position of fuel so as to improve an air/fuel ratio and engine performance.

To achieve the above object, a fuel injection mechanism for a diesel engine according to the present invention comprises a fuel injector, a driving part connected to the fuel injector for actuating the fuel injector, and a controller electrically connected to the driving part for controlling the driving part.

### BRIEF DESCRIPTION OF THE DRAWINGS

The accompanying drawings, which are incorporated in and constitute a part of the specification, illustrate an embodiment of the invention, and together with the description, serve to explain the principles of the invention.

FIG. 1 shows a behavior of a fuel mist sprayed into a combustion chamber by a fuel injector in a conventional diesel engine;

FIG. 2 is a graph for illustrating spraying patterns when the injection position is changed;

FIG. 3 is a graph for illustrating a variation of engine torque in accordance with engine rpm;

FIG. 4 is a schematic view for illustrating a conventional fuel injector for a diesel engine;

FIG. 5a is a schematic view for illustrating a fuel injection mechanism according to a preferred embodiment of the present invention;

FIG. 5b is a plane view of a stem of the fuel injection mechanism of FIG. 5a shown in direction A;

FIG. 6 is a sectional view of a fuel injector of the fuel injection mechanism of FIG. 5a where an injection position is deeply set; and

FIG. 7 is a sectional view of a fuel injector of the fuel injection mechanism of FIG. 5b where the injection position is shallowly set.

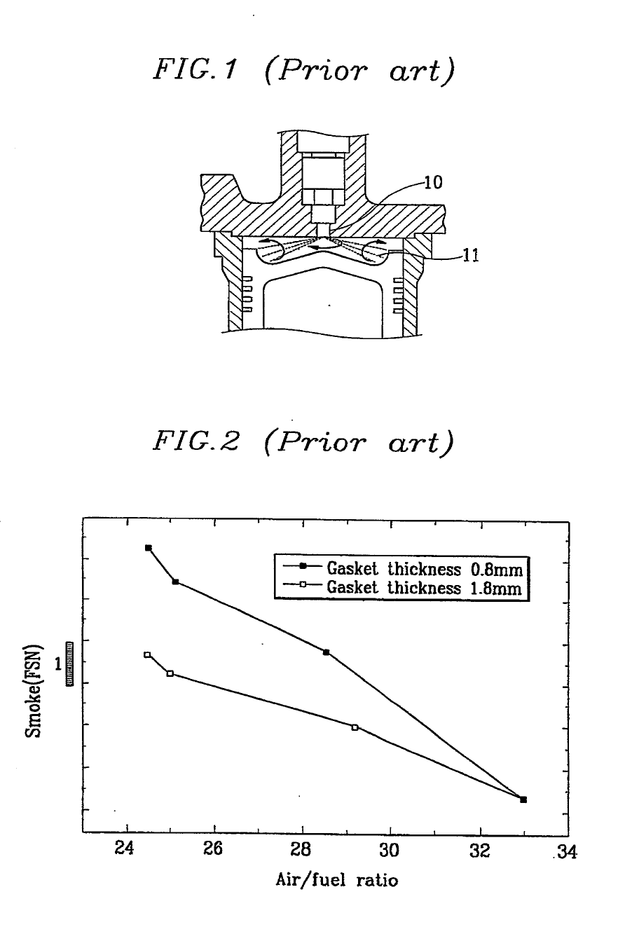

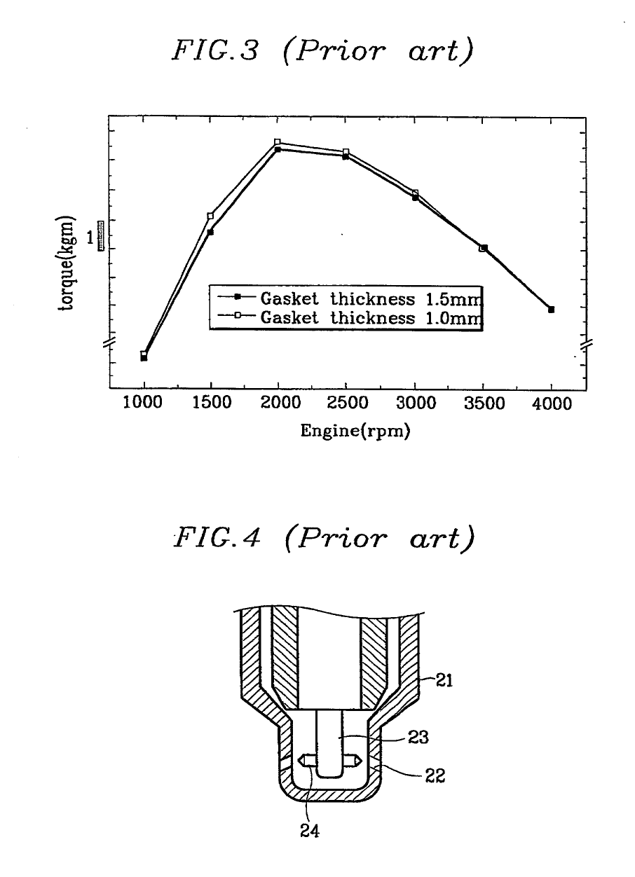

### DETAILED DESCRIPTION OF THE PREFERRED EMBODIMENTS

A preferred embodiment of the present invention will be described hereinafter with reference to the accompanying drawings.

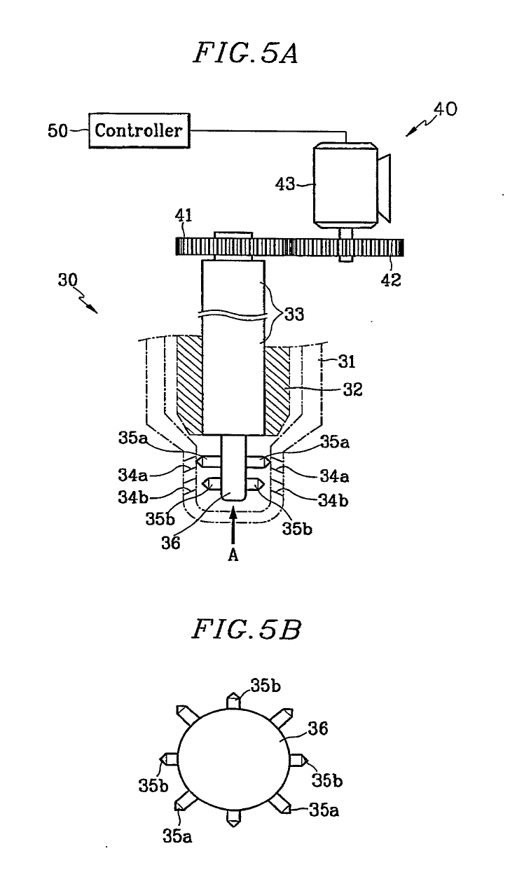

FIG. 5a and FIG. 5b are respectively a schematic view illustrating a fuel injection mechanism and a plane view of a stem of the fuel injection mechanism of FIG. 5a shown in direction A.

As shown in FIG. 5a, the fuel injection mechanism comprises a fuel injector 30, a driving part 40 for actuating the fuel injector, and a controller 50 electrically connected to the driving part 40 so as to control fuel injection.

The fuel injector 30 comprises a housing 31 provided with a plurality of upper and lower spray ports 34a and 34b formed around a closed lower end portion that is stepped so that a diameter of the lower portion is less than that of an upper portion of the housing 31, a pintle valve 32 slidably installed into the housing 31 such that a lower end of the valve 32 is seated on the stepped portion of the housing 31 when no fuel is flowing, a driving shaft 33 rotatably inserted into the valve 32, and a stem 36 mounted at a lower end of the driving shaft 33 and having a plurality of upper and lower spray valves 35a and 35b therearound corresponding to the spray ports 34a and 34b.

As shown in FIG. 5b, the upper and lower spray valves 35a and 35b are alternately arranged around the stem 36, and the upper and lower spray ports 34a and 34b are formed corresponding to the spray valves.

The driving part 40 comprises a driven gear 41 fixedly mounted at an upper end of the driving shaft 33, a driving gear 42 engaged with the driven gear 41, and a motor 43 connected to the driving gear 43 via an armature shaft for rotating the driving gear 42.

The controller 50 is electrically connected to the motor 43 of the driving part 40 so as to control the motor 43.

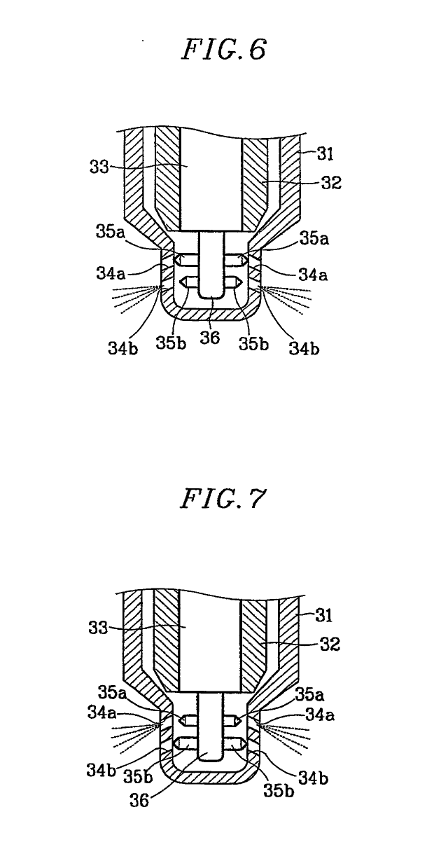

The operation of the fuel injection mechanism structured as above according to the present invention will now be described with reference to FIGS. 6 and 7.

The fuel injection mechanism of the present invention can adjust the fuel spray position by actuating specific valves among the upper and lower spray valves 35a and 35b. The spray position is selected by operating the driving part 40 under control of the controller 50 in such a way that the motor 43 of the driving parts 40 rotates in different directions according to driving conditions of the engine.

Firstly, the controller 50 detects the engine rpm and load and then determines if the present engine rpm and load are less than a predetermined value.

If the engine rpm and load are less than the predetermined value, the controller 50 operates the driving part 40 so as to extend the upper valves 35a and block fuel from being sprayed through the upper spray ports 34a of the housing 31. Accordingly, the fuel is sprayed just through the lower spray ports 34b (see FIG. 6).

On the other hand, if the engine rpm and load are equal to or greater than the predetermined value, the controller 50 operates the driving part 40 so as to extend the lower spray valves 35b and close the lower spray ports 34b of the housing 31. At the same time, the upper spray valves 35a are retracted such that the fuel is sprayed just from the upper spray ports 34a (see FIG. 7)

The driving part 40 is controlled in such a way that if it is required that 5 the spray position be deeply set, the motor 43 is controlled by the controller 50 so as to rotate the driving gear 42 in a predetermined direction such that the upper spray valves 35a of the stem 36 are extended and the lower spray valves 35b are retracted in order to spray the fuel more deeply, and if it is required that the spray position be shallowly set, the motor 43 is controlled by the controller 50 so as to rotate the driving gear 42 in an opposite direction such that the lower spray valves 35b of the stem 36 are extended and the upper spray valves 35a are retracted in order to spray the fuel therefrom.

The driving shaft 33 is provided with a position sensor (not shown) that is also electrically connected to the controller 50 such that the controller 50 can control the position of the driving shaft 33 on the basis of a signal from the position sensor.

As described above, since the fuel injection mechanism of the present invention can adjust the fuel spray position in accordance with the driving conditions by actuating specific valves among the upper and lower spray valves that are arranged around the stem in parallel, the fuel spray of the fuel injector can be optimally performed, resulting in improving engine performance and reducing emission gases at low speed.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A fuel injection mechanism for a diesel engine comprising:
a fuel injector installed in a cylinder head;
a driving part connected to the fuel injector for actuating the fuel injector; and
a controller electrically connected to the driving part for controlling the driving part.

2. A fuel injection mechanism of claim 1 wherein the fuel injector comprises:
a housing installed in a cylinder head;
a pintle valve slidably inserted into the housing;
a driving shaft rotatably inserted into the pintle valve; and
a stem mounted at a lower end of the driving shaft.

3. A fuel injection mechanism of claim 1 wherein the driving part comprises;
a driven gear mounted at an upper end of a driving shaft;
a driving gear engaged with the driven gear; and
a motor supported by a vehicle body and connected to the driving gear via an armature shaft thereof.

4. A fuel injection mechanism of claim 2 wherein the stem is provided with a plurality of spray valves therearound.

5. A fuel injection mechanism of claim 4 wherein the spray valves are alternately arranged in two rows.

6. A fuel injection mechanism of claim 5 wherein the spray valves are selectively actuated according to a rotation of a motor for adjusting a spray position.

7. A fuel injection mechanism of claim 2 wherein the housing is provided with a plurality of spray ports corresponding to spray valves.
